(19) United States
(12) Patent Application Publication
(10) Pub. No.: US 2019/0072813 A1
(43) Pub. Date: Mar. 7, 2019

(54) ELECTRO-OPTICAL DEVICE, ELECTRONIC APPARATUS, AND PROJECTOR

(71) Applicant: SEIKO EPSON CORPORATION, Tokyo (JP)

(72) Inventor: Akira MORITA, Chino-shi (JP)

(73) Assignee: SEIKO EPSON CORPORATION, Tokyo (JP)

(21) Appl. No.: 16/122,023

(22) Filed: Sep. 5, 2018

(30) Foreign Application Priority Data
Sep. 6, 2017 (JP) 2017-170930

(51) Int. Cl. G02F 1/1333; G03B 21/00; G02F 1/133; G03B 21/16; H04B 10/80

(52) U.S. Cl. CPC G02F 1/133385; G03B 21/006; G02F 1/13306; G02F 1/1368; G03B 21/16; H04B 10/80; G02F 1/133308

(57) ABSTRACT

An electro-optical device includes an electro-optical panel, a heat dissipation substrate, a first integrated circuit device disposed on the heat dissipation substrate, that drives the electro-optical panel, a second integrated circuit device, disposed on the heat dissipation substrate, that carries out interface processing between the electro-optical panel and an external device.

The present application is based on and claims priority from JP Application Serial Number 2017-170930, filed Sep. 6, 2017, the disclosure of which is hereby incorporated by reference herein in its entirety.

### BACKGROUND

### 1. Technical Field

This disclosure relates to an electro-optical device, an electronic apparatus, and a projector.

### 2. Related Art

An electro-optical device including an electro-optical panel such as a liquid crystal panel and an integrated circuit device that drives the electro-optical panel is known. For example, JP-A-2004-221570 discloses a semiconductor device including a composite integrated circuit. Here, the composite integrated circuit includes a substrate in which an inductor (a capacitor) is formed on an insulating surface, and a layer having a thin film transistor coupled with the inductor (capacitor), are layered together. JP-A-2004-221570 does not mention providing the substrate with heat dissipation functionality. JP-A-11-305254 discloses a method that makes it possible to reduce the dimensions of a frame by improving disposition relationships between extraction lines of drain wires, a panel driving IC, and a drain-side flexible substrate, but does not mention a substrate for heat dissipation. JP-A-2010-102219 discloses an electro-optical device including an electro-optical panel, first and second flexible substrates on which are formed first and second integrated circuits that drive the electro-optical panel, and a heat dissipation member to which the first and second integrated circuits are fixed in order to dissipate heat produced by the first and second integrated circuits.

In the related art in JP-A-2010-102219, the integrated circuit chips are disposed on the heat dissipation member, and Chips on Film (COF), in which the integrated circuit chips are mounted on FPC tape, are used. Regarding ease of assembly, in a case where, for example, the FPC tape is not inserted into a connector correctly when assembling the electro-optical device, terminal shorts and the like may occur. There are also cases where a reactance component produced when the FPC tape is bent causes distortion in signal waveforms, which makes it difficult to handle high-speed transmission of image data. For example, it can be difficult to handle electro-optical panels having high resolutions, such as 4K resolution.

### SUMMARY

According to some aspects of the disclosure, an electro-optical device, an electronic apparatus, a projector, and the like capable of handling high-speed transfer and improving ease of assembly are provided.

One aspect of the disclosure pertains to an electro-optical device including an electro-optical panel, a heat dissipation substrate, a first integrated circuit device disposed on the heat dissipation substrate and configured to drive the electro-optical panel, a second integrated circuit device disposed on the heat dissipation substrate and configured to carry out interface processing between the electro-optical panel and an external device, and a connector, coupled with the second integrated circuit device, that includes a signal terminal for the interface processing.

According to one aspect of the disclosure, the electro-optical panel is driven by the first integrated circuit device disposed on the heat dissipation substrate, and the interface processing between the electro-optical panel and the external device is carried out by the second integrated circuit device disposed on the heat dissipation substrate. The electro-optical device is provided with the connector including the signal terminal for the interface processing. Accordingly, heat produced by the first and second integrated circuit devices can be dissipated efficiently by the heat dissipation substrate, even when temperatures of the first and second integrated circuit devices have risen due to panel driving, the interface processing, or the like. Thus, the first and second integrated circuit devices can be operated correctly. In addition to the first integrated circuit device that carries out the panel driving, the second integrated circuit device that carries out the interface processing for data transfer with the external device, the connector coupled with the second integrated circuit device, and the like are provided, which enables high-speed data transfer between the electro-optical panel and the external device and improves the ease of assembly. As such, an electro-optical device and the like capable of handling high-speed transfer, improving the ease of assembly, and the like can be provided.

According to one aspect of the disclosure, the second integrated circuit device is configured to carry out the interface processing according to a given interface standard, and the connector may be a connector according to the given interface standard.

Accordingly, data transfer between the external device and the electro-optical device can be realized by using a connector according to a generic interface standard and coupling a cable, a bus, or the like from the external device with the connector.

According to one aspect of the disclosure, the given interface standard may be a Universal Serial Bus (USB), embedded Display Port (eDP), or High Definition Multimedia Interface (HDMI, trade name) interface standard.

Accordingly, high-speed data transfer between the external device and the electro-optical panel can be realized by coupling a cable, a bus, or the like based on USB, eDP, or HDMI with the connector.

According to an aspect of the disclosure, the first integrated circuit device may be disposed on a first direction side of the electro-optical panel, the second integrated circuit device may be disposed on the first direction side of the first integrated circuit device, and the connector may be disposed on the first direction side of the second integrated circuit device.

Accordingly, the electro-optical panel, the first integrated circuit device, the second integrated circuit device, and the connector can be disposed along the first direction, which achieves a reduction in size and the like in the electro-optical device.

One aspect of the disclosure pertains to an electro-optical device including the electro-optical panel, the heat dissipation substrate, the first integrated circuit device disposed on the heat dissipation substrate and configured to drive the electro-optical panel, the second integrated circuit device disposed on the heat dissipation substrate and configured to carry out wireless communication interface processing between the electro-optical panel and the external device, and an antenna unit for wireless communication.

According to one aspect of the disclosure, the electro-optical panel is driven by the first integrated circuit device disposed on the heat dissipation substrate, and wireless communication interface processing between the electro-optical panel and the external device is carried out by the second integrated circuit device disposed on the heat dissipation substrate. The antenna unit for the wireless communication is provided in the electro-optical device. Accordingly, heat produced by the first and second integrated circuit devices can be dissipated efficiently by the heat dissipation substrate, even when the temperatures of the first and second integrated circuit devices have risen due to the panel driving, the interface processing, or the like. Thus, the first and second integrated circuit devices can be operated correctly. In addition to the first integrated circuit device that carries out the panel driving, the second integrated circuit device that carries out the interface processing for wireless communication with the external device, the antenna unit for the wireless communication, and the like are provided, which enables data transfer between the electro-optical panel and the external device through the wireless communication, which does not require that a wire be provided, and improves the ease of assembly. As such, an electro-optical device and the like capable of handling the high-speed transfer, improving the ease of assembly, and the like can be provided.

According to an aspect of the disclosure, the first integrated circuit device may be disposed on the first direction side of the electro-optical panel, the second integrated circuit device may be disposed on the first direction side of the first integrated circuit device, and the antenna unit may be disposed on the first direction side of the second integrated circuit device.

Accordingly, the electro-optical panel, the first integrated circuit device, the second integrated circuit device, and the antenna unit can be disposed along the first direction, which achieves a reduction in size and the like in the electro-optical device.

According to one aspect of the disclosure, when viewed in plan view in a direction orthogonal to the heat dissipation substrate, the first integrated circuit device and the second integrated circuit device may be disposed overlapping the heat dissipation substrate.

By doing so, main surfaces of the first and second integrated circuit devices, which are located toward the heat dissipation substrate, can be made to face the heat dissipation substrate, and thus heat from the main surfaces can be dissipated through the heat dissipation substrate. Thus, the heat produced by the first and second integrated circuit devices can be dissipated efficiently.

According to one aspect of the disclosure, the first integrated circuit device and the second integrated circuit device may be disposed on the heat dissipation substrate with an insulating body located between the first integrated circuit device and the second integrated circuit device, and the heat dissipation substrate.

By providing an insulating body in this manner, an occurrence of problems caused by electrical couplings between the heat dissipation substrate and the first and second integrated circuit devices, for example, can be prevented.

According to one aspect of the disclosure, at least one of the electro-optical panel and the first integrated circuit device, and the first integrated circuit device and the second integrated circuit device, are coupled using bonding wires.

By carrying out wire bonding coupling in this manner, signal couplings and the like can be made with a comparatively simple manufacturing process.

According to one aspect of the disclosure, the electro-optical device may further include a silicon substrate disposed between the first and second integrated circuit devices and the heat dissipation substrate, wherein a wiring layer is formed in the silicon substrate for making at least one of a signal coupling between the electro-optical panel and the first integrated circuit device, and a signal coupling between the first integrated circuit device and the second integrated circuit device.

Accordingly, a signal coupling between the electro-optical panel and the first integrated circuit device, or a signal coupling between the first integrated circuit device and the second integrated circuit device, can be realized using a silicon substrate for signal couplings.

According to one aspect of the disclosure, the electro-optical device may include a third integrated circuit device disposed on the heat dissipation substrate, and, configured to supply power to the first integrated circuit device and the second integrated circuit device.

By providing the third integrated circuit device for power supply in this manner, a suitable power supply voltage can be supplied from the third integrated circuit device to the first and second integrated circuit devices.

According to one aspect of the disclosure, the third integrated circuit device may include a noise filter unit configured to reduce power supply noise in a given frequency band.

Accordingly, a power supply voltage generated having reduced power supply noise using the noise filter unit can be supplied from the third integrated circuit device to the first and second integrated circuit devices.

According to one aspect of the disclosure, the electro-optical device may further include a power supply connector configured to supply external power to the third integrated circuit device.

Accordingly, the external power can be supplied to the third integrated circuit device using the power supply connector. The third integrated circuit device is capable of generating the power supply voltage, and is capable of supplying a generated power supply voltage to the first and second integrated circuit devices.

According to one aspect of the disclosure, the electro-optical device may further include an inductor for non-contact power transmission, configured to supply power to the electro-optical device without making contact with the electro-optical device.

Accordingly, the electro-optical device can be operated by supplying power from the exterior to the electro-optical device in a non-contact manner, without using a cable or the like.

According to one aspect of the disclosure, the second integrated circuit device is configured to carry out image data decoding processing, and the electro-optical device may include a fourth integrated circuit device, disposed on the heat dissipation substrate, and including a memory unit for the decoding processing.

Accordingly, even in a case where a memory unit is not provided within the second integrated circuit device, the second integrated circuit device is capable of executing image data decoding processing using the memory unit for decoding processing in the fourth integrated circuit device.

According to one aspect of the disclosure, a number of pixels in the electro-optical panel may be greater than or equal to 3840×2160, and a transfer rate of the interface processing may be greater than or equal to 600 Mbps.

Using this number of pixels makes it possible to display high-resolution images using the electro-optical panel. Additionally, by using this transfer rate, even image data for displaying high-resolution images in the electro-optical panel can be received from the external device.

Another aspect of the disclosure pertains to an electronic apparatus including the electro-optical device according to any of the above-described aspects.

Another aspect of the disclosure pertains to a projector including the electro-optical device according to any of the above-described aspects, and a projection unit including a light source and an optical system.

### BRIEF DESCRIPTION OF THE DRAWINGS

Embodiments of the disclosure will be described with reference to the accompanying drawings, wherein like numbers reference like elements.

FIG. 1 is a first configuration example of an electro-optical device according to one exemplary embodiment.

FIG. 2 is a second configuration example of an electro-optical device according to one exemplary embodiment.

FIG. 3 is a third configuration example of an electro-optical device according to one exemplary embodiment.

FIG. 4 is a schematic side view of an electro-optical device according to one exemplary embodiment.

FIG. 5 is a perspective view illustrating an example of a configuration of an air cooling-type heat dissipation substrate.

FIG. 6 is a perspective view illustrating an example of a configuration of an air cooling-type heat dissipation substrate.

FIG. 7 is a perspective view illustrating an example of a configuration of a water cooling-type heat dissipation substrate.

FIG. 8 is a diagram illustrating various examples of connectors.

FIG. 9 is a schematic diagram illustrating a configuration in which a silicon substrate for signal couplings is disposed between an integrated circuit device and a heat dissipation substrate.

FIG. 10 is an example of a configuration of an integrated circuit device for panel driving.

FIG. 11 is an example of a configuration of an integrated circuit device for interface processing.

FIG. 12 is an example of a configuration of an integrated circuit device for wireless communication interface processing.

FIG. 13 is an example of a configuration of an integrated circuit device for a power supply.

FIG. 14 is an example of a configuration of an integrated circuit device for memory.

FIG. 15 is an example of a configuration of an electronic apparatus according to one exemplary embodiment.

FIG. 16 is an example of a configuration of a projector according to one exemplary embodiment.

### DESCRIPTION OF EXEMPLARY EMBODIMENTS

Some exemplary embodiments of the disclosure will be described in detail hereinafter. Note that the exemplary embodiments described hereinafter are not intended to limit the content of the disclosure as set forth in the claims, and not all of the configurations described in the exemplary embodiments are absolutely required to address the issues described in the disclosure.

1. Electro-Optical Device

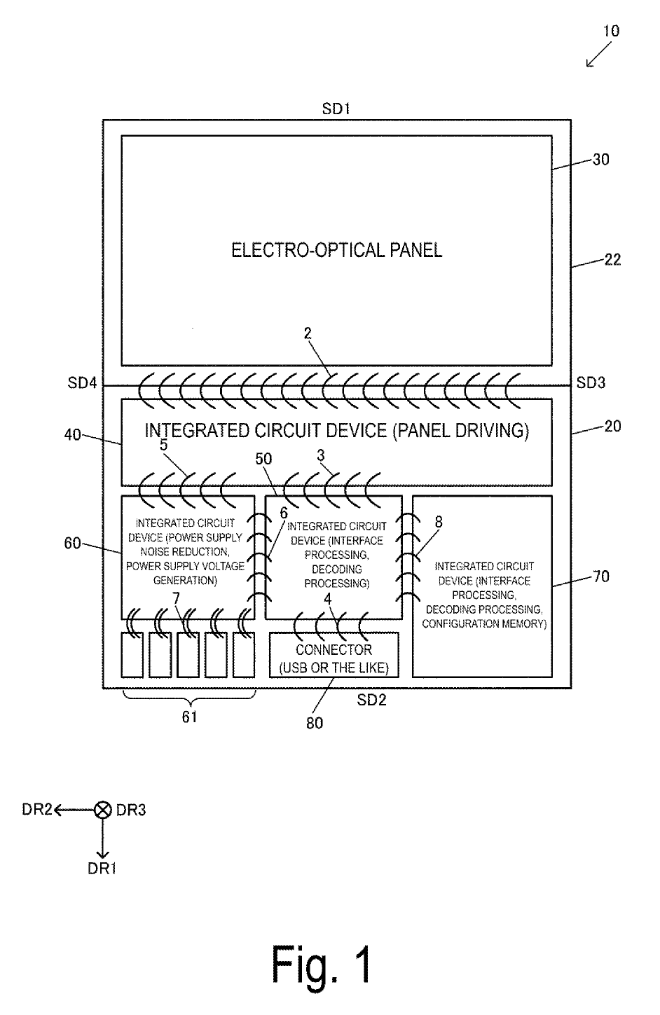

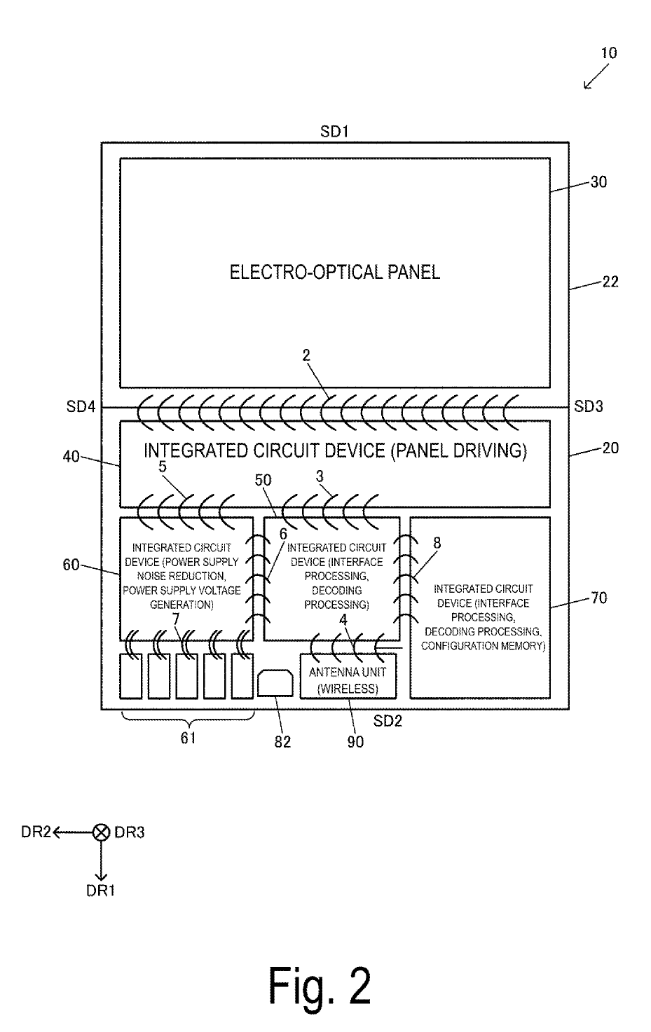

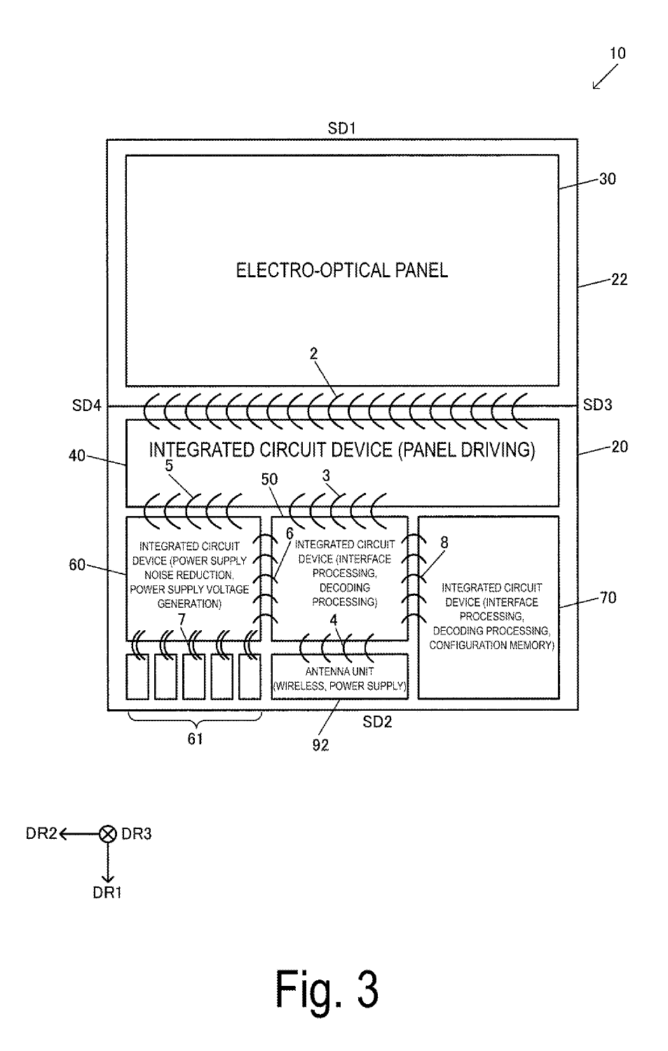

FIG. 1 illustrates a first configuration example of an electro-optical device 10 according to one exemplary embodiment. The electro-optical device 10 (panel module) includes a heat dissipation substrate 20, an electro-optical panel 30, an integrated circuit device 40 for panel driving, an integrated circuit device 50 for interface processing, and a connector 80. The electro-optical device 10 can further include integrated circuit devices 60 and 70, a frame 22 (substrate) for the electro-optical panel 30, and the like. Note that the electro-optical device 10 is not limited to the configuration illustrated in FIG. 1 (and FIGS. 2 and 3, which will be mentioned later). Many modified examples are possible, such as omitting some of these constituent elements (e.g., the integrated circuit devices 60 and 70), adding other constituent elements, and the like.

The heat dissipation substrate 20 is a substrate (a member) for dissipating heat produced by the integrated circuit devices 40, 50, and the like (the integrated circuit devices 40, 50, 60, and 70; the same applies hereinafter). The heat dissipation substrate 20 (a heat dissipation member) is formed from a metal having high thermal conductivity, such as magnesium or aluminum. Alternatively, the heat dissipation substrate 20 may be formed from ceramics, silicon, or the like, or may be formed from a thermally-conductive insulating body such as thermally-conductive plastic. The heat dissipation substrate 20 is a member whose main face is rectangular (substantially rectangular), for example.

The electro-optical panel 30 is a panel for displaying images, and can be implemented as a liquid crystal panel, an organic EL panel, or the like, for example. An active-matrix panel using switching elements such as thin film transistors (TFTs) can be employed as the liquid crystal panel. The electro-optical panel 30 is held in the frame 22 when the electro-optical device 10 is assembled (manufactured). When held in the frame 22, the electro-optical panel 30 and the frame 22 are bonded to each other using, for example, a silicon-based molding agent. The frame 22 may function as a heat dissipation member. For example, although the heat dissipation substrate 20 and the frame 22 are formed separately in FIG. 1, these elements may be formed as an integral entity to serve as a heat dissipation substrate.

The electro-optical panel 30 (a display panel) includes a plurality of pixels. The plurality of pixels are disposed in a matrix, for example. The electro-optical panel 30 also includes a plurality of data lines (source lines) and a plurality of scanning lines (gate lines) laid in a direction intersecting with the plurality of data lines. Each pixel among the plurality of pixels is disposed at a region where each data line and each scanning line intersect. In an active-matrix panel, a switching element such as a thin film transistor (TFT) is disposed at each pixel region. The electro-optical panel 30 realizes display operations by causing the optical properties of electro-optical elements (liquid-crystal elements, EL elements, or the like) at the pixel regions to change. Note that in an organic EL panel, pixel circuits for driving the EL elements with current are disposed at each pixel region.

The integrated circuit device 40 (a first integrated circuit device) is disposed on the heat dissipation substrate 20. The integrated circuit device 40 (a panel driving IC) drives the electro-optical panel 30. For example, the data lines of the electro-optical panel 30 are driven based on a power supply voltage for driving, supplied from the integrated circuit device 60 for power supply. For example, the data lines (source lines) are driven by supplying data voltages (source voltages) based on image data (display data, tone data). The integrated circuit device 40 may drive the scanning lines of the electro-optical panel 30. For example, the integrated circuit device 40 may drive the scanning lines by supplying selection voltages for selecting the scanning lines (gate lines) in sequence. Note that a plurality of the integrated circuit devices 40 may be provided, and the electro-optical panel 30 may be driven by the plurality of integrated circuit devices 40.

The integrated circuit device 50 (a second integrated circuit device) is disposed on the heat dissipation substrate 20. The integrated circuit device 50 carries out interface processing between the electro-optical panel 30 (the integrated circuit device 40) and an external device. The external device is a device provided outside the electro-optical device 10, and is a device such as a processing device or a main board on which a processing device is mounted, for example. The interface processing is, for example, a process of receiving image data used to display an image in the electro-optical panel 30 from the external device, a process of receiving instruction information such as various types of commands from the external device, a process of sending various types of status information to the external device, or the like. As will be described later, the integrated circuit device 50 carries out interface processing based on a given interface standard (communication standard, communication specification) such as USB, for example. The integrated circuit device 50 may carry out a decoding process such as a process of decompressing received image data.

The connector 80 is coupled with the integrated circuit device 50, and includes a signal terminal for interface processing. The connector 80 is coupled with the external device by an external bus (USB or the like) for interface processing. The signal terminal for interface processing is a data terminal (e.g., a DP or DM terminal in USB) used in the interface processing of the integrated circuit device 50, for example. The connector 80 may include a power supply terminal (e.g., a VBUS terminal), a clock terminal, or the like in addition to the data terminal. The connector 80 has a shape that enables coupling with a bus (e.g., USB) for interface processing, for example, and is a connector compliant with a given interface standard such as USB, for example.

The integrated circuit device 60 (a third integrated circuit device) is disposed on the heat dissipation substrate 20. The integrated circuit device 60 supplies a power supply voltage to the integrated circuit devices 40, 50 and the like (the integrated circuit devices 40, 50, and 70). For example, the power supply voltage is generated and supplied to the integrated circuit devices 40, 50, and the like. The integrated circuit device 60 carries out filter processing for reducing (absorbing) power supply noise. For example, the integrated circuit device 60 carries out noise filter processing that reduces power supply noise in a given frequency band. Note that various types of passive elements 61 are coupled with the integrated circuit device 60 as external components. The passive elements 61 are capacitors, resistors, or inductors, for example. The passive elements 61 are disposed on the heat dissipation substrate 20, for example. The integrated circuit device 60 carries out the noise filter processing, the processing of generating the power supply voltage, and the like using the passive elements 61 such as capacitors, resistors, or inductors, for example. For example, the integrated circuit device 60 uses the passive elements 61 to carry out band-eliminating filter processing that attenuates a frequency band component of power supply noise (notch filter processing). Alternatively, the integrated circuit device 60 uses the passive elements 61 to generate various types of power supply voltages by carrying out charge pump type or switching regulator type DC-DC conversion processing.

The integrated circuit device 70 (a fourth integrated circuit device) is a circuit device, disposed on the heat dissipation substrate 20, including various types of memory units. For example, the integrated circuit device 50 carries out a decoding process such as a process for decompressing compressed image data, and in this case, the integrated circuit device 70 includes a memory unit for decoding processing. The integrated circuit device 70 can also include a memory unit for interface processing, a memory unit for settings such as system settings, and the like. These memory units can be realized by semiconductor memory such as SRAM or DRAM, for example.

In FIG. 1, the integrated circuit device 40 is disposed on a direction DR1 side (a first direction side) of the electro-optical panel 30, and the integrated circuit device 50 is disposed on a direction DR1 side of the integrated circuit device 40. The connector 80 is disposed on a direction DR1 side of the integrated circuit device 50. For example, the integrated circuit device 40 is disposed adjacent to the electro-optical panel 30. The integrated circuit device 50 is disposed adjacent to the integrated circuit device 40, and the connector 80 is disposed adjacent to the integrated circuit device 50. For example, the integrated circuit device 40 is disposed between the electro-optical panel 30 and the integrated circuit device 50, and the integrated circuit device 50 is disposed between the integrated circuit device 40 and the connector 80. When a direction intersection with (orthogonal to) the direction DR1 is taken as a direction DR2 (a second direction), the integrated circuit device 60 is disposed on a direction DR2 side of the integrated circuit device 50, and the integrated circuit device 70 is disposed on a side of the integrated circuit device 50 opposite from the direction DR2. For example, the integrated circuit device 60 is disposed adjacent to the integrated circuit device 50, and the integrated circuit device 70 is disposed adjacent to the integrated circuit device 50. For example, the integrated circuit device 50 is disposed between the integrated circuit device 60 and the integrated circuit device 70. When viewed in plan view from a direction DR3 orthogonal to (intersecting with) the heat dissipation substrate 20, the integrated circuit devices 40 and 50 are disposed so as to overlap with the heat dissipation substrate 20. Likewise, when viewed in plan view from a direction DR3 orthogonal to the heat dissipation substrate 20, the integrated circuit devices 60 and 70 are disposed so as to overlap with the heat dissipation substrate 20.

Here, the direction DR1 is, for example, a direction from a side SD1 (a first side) of the electro-optical device 10 toward a side SD2 (a second side) that faces SD1. When sides of the electro-optical device 10 intersecting with (orthogonal to) the sides SD1 and SD2 are taken as a side SD3 (a third side) and a side SD4 (a fourth side), the direction DR2 is a direction from the side SD3 toward the side SD4 that faces SD3. The direction DR3 is a direction intersecting with (orthogonal to) the direction DR1 and the direction DR2. For example, a direction orthogonal to the heat dissipation substrate 20 is the direction DR3.

FIG. 2 illustrates a second configuration example of the electro-optical device 10 according to one exemplary embodiment. In the second configuration example illustrated in FIG. 2, an antenna unit 90 is provided instead of the connector 80 illustrated in FIG. 1. Additionally, a power supply connector 82 is provided in the second configuration example. For example, in the second configuration example, the integrated circuit device 50 disposed on the heat dissipation substrate 20 carries out wireless communication interface processing between the electro-optical panel 30 and an external device. For example, the integrated circuit device 50 carries out interface processing for wireless communication such as Wi-Fi (trade name) or Bluetooth (trade name). The antenna unit 90 is an antenna unit for this wireless communication, and is realized by an inductor and the like. The inductor that realizes the antenna unit 90 may be formed on the heat dissipation substrate 20, for example, or may be formed within the integrated circuit device 50 for wireless communication, for example. For example, the inductor of the antenna unit 90 may be realized by a metal layer (pad metal) in an uppermost layer of the integrated circuit device 50.

The power supply connector 82 is a connector for supplying an external power supply to the integrated circuit device 60 for power supply. For example, a power supply voltage from an external device is supplied to the integrated circuit device 60 via the power supply connector 82. Note that in the first configuration example illustrated in FIG. 1, the connector 80 also functions as the power supply connector 82, and supplies the power supply voltage from the external device to the integrated circuit device 60 via the connector 80.

In FIG. 2, the integrated circuit device 40 is disposed on the direction DR1 side of the electro-optical panel 30, and the integrated circuit device 50 is disposed on the direction DR1 side of the integrated circuit device 40. The antenna unit 90 is disposed on the direction DR1 side of the integrated circuit device 50. For example, the antenna unit 90 is disposed adjacent to the integrated circuit device 50. For example, the integrated circuit device 40 is disposed between the electro-optical panel 30 and the integrated circuit device 50, and the integrated circuit device 50 is disposed between the integrated circuit device 40 and the antenna unit 90.

FIG. 3 illustrates a third configuration example of the electro-optical device 10 according to one exemplary embodiment. In the third configuration example illustrated in FIG. 3, an antenna unit 92 for power supply is provided. For example, the antenna unit 92 of the third configuration example includes an inductor (a coil) for non-contact power transmission, for supplying power to the electro-optical panel 30 without making contact with the electro-optical panel 30. For example, the antenna unit 92 can include the inductor for non-contact power transmission and an inductor for wireless communication. Note that in a case where the integrated circuit device 50 carries out interface processing for wired communication such as USB instead of wireless communication, the antenna unit 92 illustrated in FIG. 3 is provided only with the inductor for non-contact power transmission.

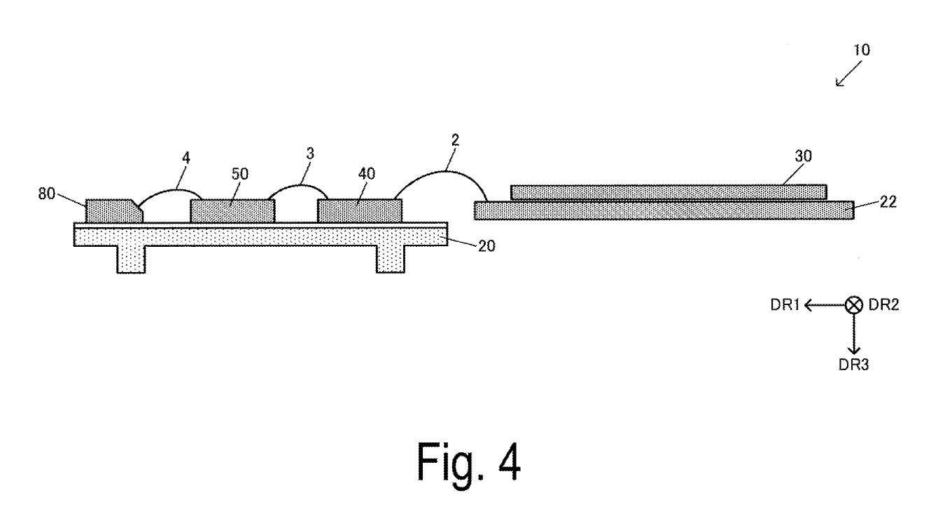

FIG. 4 is a schematic side view of the electro-optical device 10. As illustrated in FIG. 4, the electro-optical panel 30 is attached to the frame 22. The integrated circuit device 40 for panel driving, the integrated circuit device 50 for interface processing, and the connector 80 are mounted on the heat dissipation substrate 20. For example, in a case where the direction orthogonal to the heat dissipation substrate 20 is taken as DR3, the heat dissipation substrate 20 is disposed on the direction DR3 side (a bottom side) of the integrated circuit devices 40 and 50. Additionally, the integrated circuit device 40 is disposed on the direction DR1 side of the electro-optical panel 30. The integrated circuit device 50 is disposed on the direction DR1 side of the integrated circuit device 40, and the connector 80 is disposed on the direction DR1 side of the integrated circuit device 50.

Note that a modified example in which the connector 80 is not mounted on the heat dissipation substrate 20 is also possible. Additionally, in the second and third configuration examples illustrated in FIGS. 2 and 3, the antenna unit 90 or the antenna unit 92 is disposed in the location of the connector 80 in FIG. 4. Also, although the heat dissipation substrate 20 and the frame 22 (the substrate for the electro-optical panel 30) are separately formed in FIG. 4, these elements may be formed as an integral entity to serve as a heat dissipation substrate.

The electro-optical panel 30 and the integrated circuit device 40 are coupled by bonding wires 2. The integrated circuit device 40 and the integrated circuit device 50 are coupled by bonding wires 3. The integrated circuit device 50 and the connector 80 (or the antenna unit 90 or 92) are coupled by bonding wires 4. As illustrated in FIGS. 1, 2, and 3, the integrated circuit device 60 and the integrated circuit device 40 are coupled by bonding wires 5, the integrated circuit device 60 and the integrated circuit device 50 are coupled by bonding wires 6, and the integrated circuit device 60 and the passive elements 61 are coupled by bonding wires 7. The integrated circuit device 50 and the integrated circuit device 70 are coupled by bonding wires 8. As illustrated in FIGS. 2 and 3, the integrated circuit device 50 and the antenna unit 90 or the antenna unit 92 are coupled by the bonding wires 4. Coupling by the bonding wires 2 to 8 is carried out in a wire bonding process when assembling (manufacturing) the electro-optical device 10, for example. Coupling of the bonding wires 2 to 8 is carried out using a wire bonding device, for example.

In a case where the heat dissipation substrate 20 is formed from a conductive member such as magnesium or aluminum, and the electric potential of the heat dissipation substrate 20 and the electric potential of back surfaces of the IC chips such as the integrated circuit devices 40, 50, and the like have the same electric potential, the integrated circuit devices 40, 50, and the like are mounted directly on the heat dissipation substrate 20. However, in a case where the electric potentials are different, the surface of the heat dissipation substrate 20 on the side of the integrated circuit devices 40 and 50 is insulated by an oxide film or the like, or is insulated by an insulating material such as polyimide, before mounting the integrated circuit devices 40, 50, and the like. In a case where the heat dissipation substrate 20 is formed from a thermally-conductive insulating body, such as thermally-conductive plastic, the integrated circuit devices 40, 50, and the like are mounted directly on the heat dissipation substrate 20.

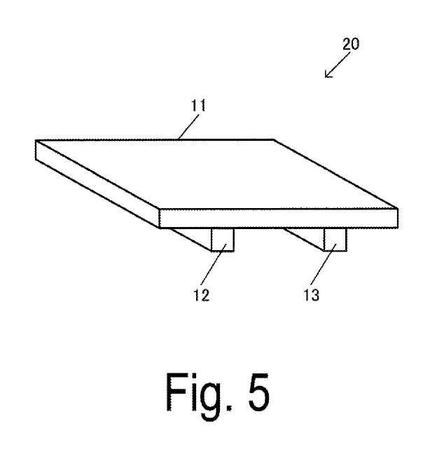

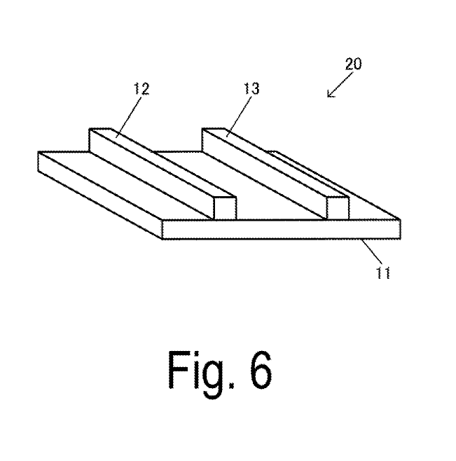

FIG. 5 is a perspective view illustrating the shape of a front side of an air cooling-type heat dissipation substrate 20, and FIG. 6 is a perspective view illustrating the shape of a rear side. The heat dissipation substrate 20 includes a base part 11 that is flat-plate-shaped, and air cooling fins 12 and 13 disposed on a rear side of the base part 11 (a surface on a side opposite from a surface integrated circuit device attachment surface). A heat dissipation effect can be increased by providing the fins 12 and 13. Note that the number of the fins 12 and 13 is not limited to two, and may be one, or three or more. Shapes of the fins 12 and 13 are not limited to shapes illustrated in FIGS. 5 and 6, and many modified examples are possible.

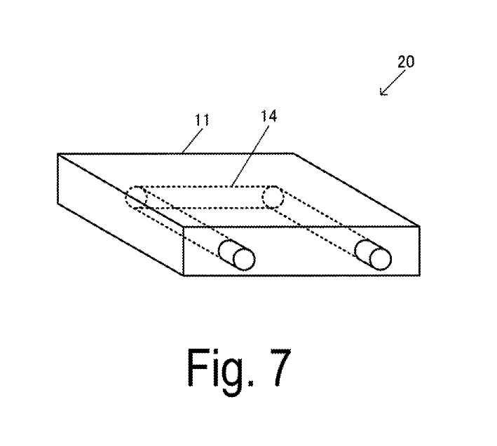

FIG. 7 is a perspective view illustrating an example of the configuration of a water cooling-type heat dissipation substrate 20. The water cooling-type heat dissipation substrate 20 includes the base part 11, and a water cooling pipe 14 disposed within the base part 11. A cooling fluid flows in the pipe 14. Heat can be dissipated by, for example, using a pump or the like (not illustrated) to cause the cooling fluid to flow in the pipe 14 that is within the base part 11.

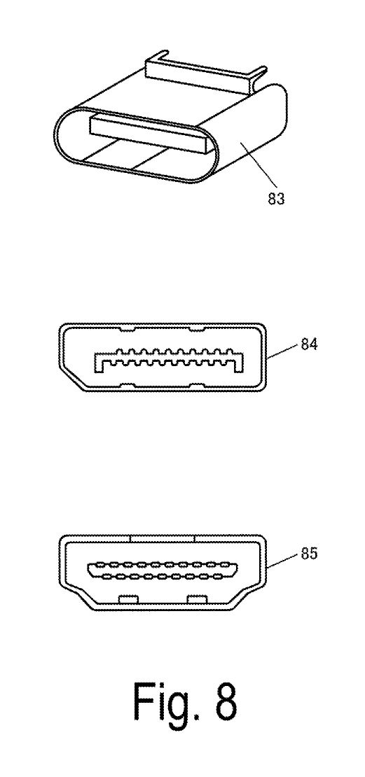

FIG. 8 illustrates a specific example of the configuration of the connector 80 of FIG. 1. A connector 83 is a Universal Serial Bus (USB) Type-C connector. A USB Type-C connector 83 is a connector that is smaller than the standard Type-A and Type-B, can be used on both the host side and the device side, and has a reversible structure. USB Type-C supports a variety of standards, such as the existing USB 2.0 and USB 3.0 standards, USB 3.1, which is capable of high-speed data transfer at 10 Gbps, and USB Power Delivery (USB PD), USB Billboard (USB BB), USB Battery Charging (USB BC), and the like. For example, with USB Power Delivery, a very high amount of power, e.g., 20 V×5 A, can be supplied. The USB Type-C specification also includes a control mode called Alternate Mode as an optional function. In Alternate Mode, data can be transferred according to standards aside from USB by using a USB Type-C cable or the like. Thunderbolt, Thunderbolt 3, and the like can be realized by using Alternate Mode. For example, with Thunderbolt 3, extremely high-speed data transfer, i.e., 40 Gbps, is possible.

A connector 84 is a Display Port connector such as embedded Display Port (eDP). The eDP standard is a standard that aims to achieve higher speeds than existing LVDS and reduce the number of signals. eDP uses Display Port, which is a digital interface standard, as a base, with Display Port being altered for embedded wiring within a device. eDP is capable of data transfer at, for example, 5.4 Gbps per lane. A connector 85 is a High Definition Multimedia Interface (HDMI) connector. HDMI is an interface standard for inputting and outputting digital video and audio, which expands upon the existing DVI for use as an interface in home electronics and AV devices, and is capable of transferring video and audio over a single cable.

Thus, according to one exemplary embodiment, in a case where the integrated circuit device 50 carries out interface processing according to a given interface standard, the connector 80 is a connector for the given interface standard. In other words, the connector is compliant with the given interface standard. Specifically, as illustrated in FIG. 8, the connector 80 is implemented as the connector 83, the connector 84, or the connector 85, which are compliant with USB, eDP, or HDMI, respectively, as the given interface standard.

As described above and as illustrated in FIG. 1, the electro-optical device 10 according to one exemplary embodiment includes the electro-optical panel 30, the heat dissipation substrate 20, the integrated circuit device 40, which is disposed on the heat dissipation substrate 20 and drives the electro-optical panel 30, the integrated circuit device 50, which is disposed on the heat dissipation substrate 20 and carries out interface processing between the electro-optical panel 30 and the external device, and the connector 80, which is coupled with the integrated circuit device 50 and includes a signal terminal for interface processing.

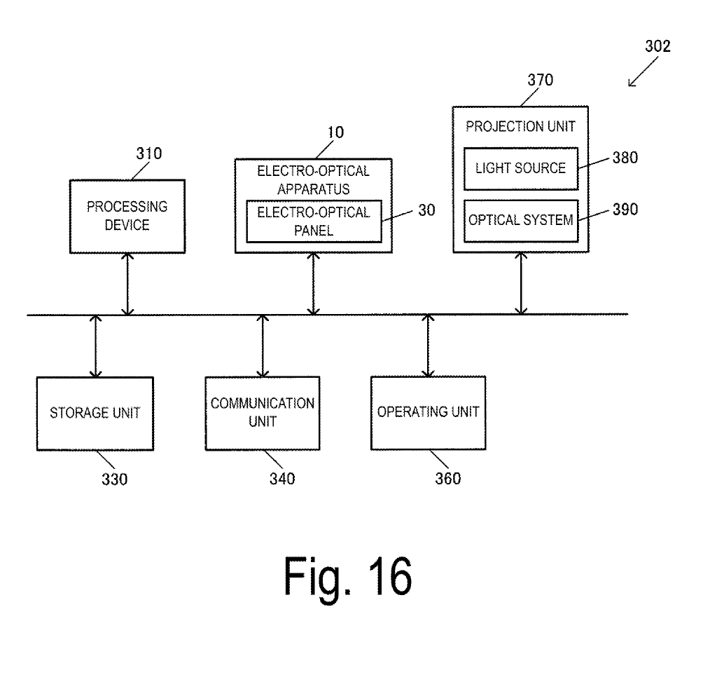

By disposing the integrated circuit devices 40 and 50 on the heat dissipation substrate 20 in this manner, heat produced by the integrated circuit devices 40 and 50 can be dissipated efficiently by the heat dissipation substrate 20, even when the temperatures of the integrated circuit devices 40 and 50 have risen due to panel driving, interface processing, or the like. The integrated circuit devices 40 and 50 can therefore be operated correctly, and thus the occurrence of incorrect images being displayed in the electro-optical panel 30, erroneous operations of the electro-optical device 10 caused by heat, and the like can be prevented effectively. Note that the image displayed in the electro-optical panel 30 can be used as a projection image of a projector 302, for example, which is illustrated in FIG. 16 and will be described later.

Additionally, according to one exemplary embodiment, the integrated circuit device 50 that carries out interface processing for transferring data with an external device, the connector 80 coupled with the integrated circuit device 50, and the like are provided in the electro-optical device 10, in addition to the integrated circuit device 40 that carries out panel driving. Accordingly, by, for example, coupling a cable from the external device with the connector 80, high-speed data transfer based on the standard of the interface processing, for example, can be carried out between the electro-optical panel 30 and the external device. Thus, even in a case where the electro-optical panel 30 is a high-resolution panel, such as 4K, the image data required for the high-resolution display can be received from the external device through high-speed data transfer at greater than or equal to 600 Mbps, for example. Accordingly, a high-resolution image, such as where the number of pixels is greater than or equal to 3840×2160, for example, can be displayed in the electro-optical panel 30.

Additionally, according to one exemplary embodiment, a generic connector compliant with an interface standard can be used as the connector 80. Accordingly, a cable from an information processing device (an external device) such as a personal computer (PC), a laptop PC, a tablet PC, or a smartphone can be coupled with the connector 80, and image data can be received directly from the information processing device. As a result, high-resolution images expressed by the image data from the information processing device can be displayed in the electro-optical panel 30, displayed as a projection image, or the like, and thus usage cases not possible thus far can be realized by the electro-optical device 10.

In the above-described related art, for example, a COF in which an integrated circuit device is mounted on FPC tape is used. Accordingly, there are cases where, for example, a reactance component produced when the FPC tape is bent causes distortion in signal waveforms, which makes it difficult to handle high-speed transfer of image data. There has also been an issue in that when assembling (manufacturing) the electro-optical device, the connector of the FPC tape has been inserted at an angle, causing the occurrence of terminal shorts.

With respect to this point, according to one exemplary embodiment, image data of high resolution images can be received through high-speed data transfer by the interface processing of the integrated circuit device 50, simply by coupling a cable from an external device with the connector 80 of the electro-optical device 10. For coupling with the external device, a cable, bus, or the like from the external device need only be coupled with the connector 80, and FPC tape need not be used. Accordingly, terminal shorts and the like caused by angled insertion do not occur, and the ease of assembly can also be improved.

Additionally, according to one exemplary embodiment, the integrated circuit device 50 carries out interface processing compliant with a given interface standard, and the connector 80 is a connector compliant with the given interface standard. Specifically, as illustrated in FIG. 8, the given interface standard is an interface standard such as USB, eDP, or HDMI. Note that the interface standard is not limited, and a standard that is an extension of USB, eDP, or HDMI, a standard aside from USB, eDP, or HDMI, or the like may be used.

Thus, by using the connector 80, which is compliant with a generic interface standard, a cable from an information processing device such as a PC or a smartphone, for example, can be coupled with the connector 80, and image data from the information processing device can be received directly. For example, with USB, image data can be received through high-speed data transfer using USB 3.1 or the like, and image data (video data) can be received using a USB Alternate Mode, or the like, and as a result, images can be displayed in the electro-optical panel 30, and a projection image can be displayed. Thus, types of image display systems that were not possible thus far can be realized. Additionally, by using the connector 80 based on a USB standard or the like, power can be supplied to the electro-optical device 10 from the exterior via the connector 80. For example, power from the exterior can be supplied to the electro-optical device 10 using VBUS or the like in USB.

Additionally, according to one exemplary embodiment, the integrated circuit device 40 is disposed on the direction DR1 side of the electro-optical panel 30, the integrated circuit device 50 is disposed on the direction DR1 side of the integrated circuit device 40, and the connector 80 is disposed on the direction DR1 side of the integrated circuit device 50, as illustrated in FIG. 1. Accordingly, the electro-optical panel 30, the integrated circuit devices 40 and 50, and the connector 80 can be disposed in a compact manner along the direction DR1. For example, the electro-optical panel 30, the integrated circuit devices 40 and 50, and the connector 80 can be disposed adjacent to each other along the direction DR1. Accordingly, the electro-optical device 10 can be made smaller and thinner, and an electronic apparatus into which the electro-optical device 10 is incorporated can be made more compact as well. Additionally, because the electro-optical panel 30, the integrated circuit devices 40 and 50, and the connector 80 can be disposed close to each other, signal couplings can be made using short bonding wires 2, 3, 4, and the like. This makes it possible to reduce negative effects caused by parasitic capacitance, parasitic resistance, and the like in the wires, which in turn makes it possible to realize better performance and the like in the electro-optical device 10.

Additionally, as illustrated in FIG. 2, the electro-optical device 10 according to one exemplary embodiment includes the electro-optical panel 30, the heat dissipation substrate 20, the integrated circuit device 40, which is disposed on the heat dissipation substrate 20 and drives the electro-optical panel 30, the integrated circuit device 50, which is disposed on the heat dissipation substrate 20 and carries out wireless communication interface processing between the electro-optical panel 30 and an external device, and a wireless communication antenna unit 90.

According to this configuration, heat produced by the integrated circuit devices 40 and 50 can be efficiently dissipated by the heat dissipation substrate 20, and thus the integrated circuit devices 40 and 50 can be operated correctly. Accordingly, when the image displayed in the electro-optical panel 30 is an incorrect image, erroneous operations or the like occurring in the electro-optical device 10, and the like can be effectively prevented.

In addition to the integrated circuit device 40 that carries out panel driving, the integrated circuit device 50 for wireless communication interface processing with an external device, the wireless communication antenna unit 90, and the like are disposed on the electro-optical device 10. By doing so, data transfer through wireless communication can be carried out between the electro-optical panel 30 and the external device over wireless LAN, Bluetooth, or the like, for example. Accordingly, image data necessary for high-resolution display can be received through high-speed wireless communication, and a high-resolution image can be displayed. Additionally, an information processing device such as a PC or a smartphone is capable of establishing a direct communication coupling with the electro-optical device 10 wirelessly, over a wireless LAN or the like, and image data and the like can be transferred from the information processing device. Accordingly, an image display system in which the electro-optical device 10 including the electro-optical panel 30 (panel module) and an information processing device establish a direct communication coupling wirelessly can be realized.

In FIG. 2, the power supply connector 82 for supplying external power to the integrated circuit device 60 is provided. Accordingly, external power can be supplied to the integrated circuit device 60 using the power supply connector 82. The integrated circuit device 60 is capable of generating a power supply voltage, and is capable of supplying the generated power supply voltage to the integrated circuit devices 40, 50, 70, and the like. Additionally, as illustrated in FIG. 2, in a case where the wireless communication antenna unit 90 and the power supply connector 82 are provided, data can be transferred using wireless communication, which makes a wire unnecessary. Thus, only a power supply line of the power supply connector 82 needs to be provided.

In FIG. 2, the integrated circuit device 40 is disposed on the direction DR1 side of the electro-optical panel 30, the integrated circuit device 50 is disposed on the direction DR1 side of the integrated circuit device 40, and the antenna unit 90 is disposed on the direction DR1 side of the integrated circuit device 50. Accordingly, the electro-optical panel 30, the integrated circuit devices 40 and 50, and the antenna unit 90 can be disposed in a compact manner along the direction DR1. Accordingly, the electro-optical device 10 can be made smaller and thinner, and an electronic apparatus into which the electro-optical device 10 is incorporated can be made more compact as well. Additionally, because the electro-optical panel 30, the integrated circuit devices 40 and 50, and the antenna unit 90 can be disposed close to each other, signal couplings can be made using short bonding wires 2, 3, 4, and the like. This makes it possible to reduce negative effects caused by parasitic capacitance, parasitic resistance, and the like in the wires, which in turn makes it possible to realize better performance and the like in the electro-optical device 10.

In FIGS. 1, 2, and 3, when viewed in plan view from the direction DR3 orthogonal to the heat dissipation substrate 20, the integrated circuit devices 40, 50, and the like are disposed so as to overlap with the heat dissipation substrate 20. In other words, the electro-optical device 10 is assembled so that the heat dissipation substrate 20 is located on the direction DR3 side of the integrated circuit devices 40, 50, and the like, for example. By doing so, main surfaces of the integrated circuit devices 40, 50, and the like, which are located toward the heat dissipation substrate 20, can be made to face the heat dissipation substrate 20, and thus heat from those main surfaces, which have broad surface areas, can be dissipated through the heat dissipation substrate 20. Accordingly, heat produced by the integrated circuit devices 40, 50, and the like can be efficiently dissipated, and the occurrence of problems in the operations of the integrated circuit devices 40, 50, and the like, caused by heat, can be prevented.

Additionally, the electro-optical device 10 according to one exemplary embodiment includes the integrated circuit device 60, which is disposed on the heat dissipation substrate 20 and supplies a power supply voltage to the integrated circuit devices 40, 50, and the like. By providing the integrated circuit device 60 for power supply in this manner, the power supply noise can be reduced, and various types of power supply voltages required by the integrated circuit devices 40, 50, and the like can be generated and supplied. For example, the integrated circuit device 40 requires a power supply voltage for driving the electro-optical panel 30, and providing the integrated circuit device 60 makes it possible to supply this power supply voltage for driving to the integrated circuit device 40. In a case where the integrated circuit device 50 for interface processing is formed through a low-breakdown voltage manufacturing process with short transistor channel lengths in order to increase speeds, the integrated circuit device 60 can generate a low-voltage power supply voltage and supply the voltage to the integrated circuit device 50, for example.

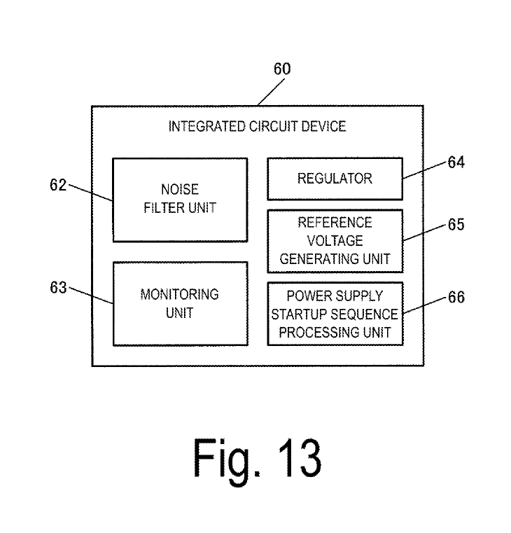

For example, as illustrated in FIG. 13, which will be described later, the integrated circuit device 60 includes a noise filter unit 62 that reduces power supply noise in a given frequency band. The noise filter unit 62 carries out band-elimination filter processing that reduces a power supply noise frequency band component, for example. This filter processing can be realized using, for example, the passive elements 61 disposed on the heat dissipation substrate 20. Accordingly, various types of power supply voltages generated having reduced (removed) power supply noise using the noise filter unit 62 can be supplied from the integrated circuit device 60 to the integrated circuit devices 40, 50, and the like.

As illustrated in FIG. 3, according to one exemplary embodiment, the non-contact power transmission antenna unit 92 for supplying power to the electro-optical device 10 without making contact with the electro-optical device 10 may be provided. Accordingly, the power supply connector 82 illustrated in FIG. 2 is not needed, and the electro-optical device 10 can be operated by supplying power from the exterior to the electro-optical panel 30 in a non-contact manner, without using a cable or the like. In non-contact power transmission, for example, a power transmission coil (primary coil, primary inductor) provided on a power transmission side and a power receiving coil (secondary coil, secondary inductor) provided on a power receiving side are electromagnetically coupled to form a power transmission transformer, which realizes non-contact power transmission. In this case, the antenna unit 92 of the electro-optical device 10 illustrated in FIG. 3 is provided with the inductor of the power receiving coil.

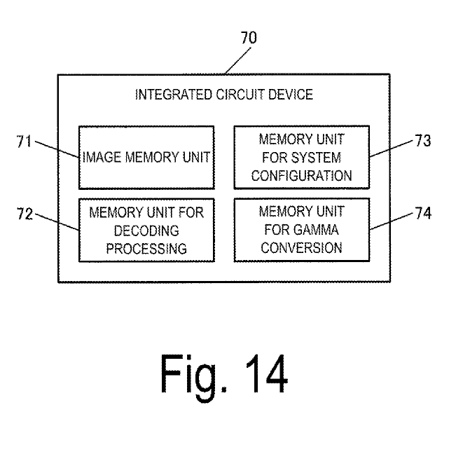

Additionally, the integrated circuit device 50 for interface processing may carry out an image data decoding process. For example, in a case where the image data is encoded according to a given encoding method, the integrated circuit device 50 carries out decoding processing that decodes the encoded image data. Specifically, in a case where the image data received through the interface processing, for example, is compressed, the integrated circuit device 50 carries out decoding processing for decompressing the compressed image data. In this case, the integrated circuit device 70 includes a memory unit 72 for decoding processing (compression/decompression), as illustrated in FIG. 14, and as described later. The integrated circuit device 50 carries out the decoding processing, such as decompression processing, using the memory unit 72 as a work region, for example. Accordingly, even in a case where a memory unit is not provided within the integrated circuit device 50, image data decoding processing can be executed using the memory unit 72 of the integrated circuit device 70, which is provided outside the integrated circuit device 50. For example, using the integrated circuit device 70 manufactured through a manufacturing process for memory in order to realize a high-capacity memory is advantageous in terms of reducing costs and reducing the size of the apparatus.

In the electro-optical panel according to one exemplary embodiment, it is desirable that the number of pixels be greater than or equal to 3840×2160, for example, and that the transfer rate of the interface processing by the integrated circuit device 50 be greater than or equal to 600 Mbps. Using this number of pixels makes it possible to display high-resolution images using the electro-optical panel 30. To display high-resolution images, it is necessary for the electro-optical apparatus 10 to receive the image data from the external device at a high transfer rate. With respect to this point, in a case where the transfer rate of the interface processing by the integrated circuit device 50 is greater than or equal to 600 Mbps (pr greater than or equal to 1 Gbps), the image data can be received at this high transfer rate. This makes it possible to display high-resolution images having a pixel number greater than or equal to 3840×2160, and thus displays at 4K resolutions, for example, can be handled as well.

Additionally, according to one exemplary embodiment, bonding wires are used to couple at least one of the electro-optical panel 30 to the integrated circuit device 40 and the integrated circuit device 40 to the integrated circuit device 50. For example, in FIGS. 1 to 3, the electro-optical panel 30 and the integrated circuit device 40 are coupled by the bonding wires 2, and the integrated circuit device 40 and the integrated circuit device 50 are coupled by the bonding wires 3. It is also possible to couple either the electro-optical panel 30 and the integrated circuit device 40, or the integrated circuit device 40 and the integrated circuit device 50, using bonding wires, and couple the other set of these elements through another form of coupling. For example, the electro-optical panel 30 may be coupled with the integrated circuit device 40, or the integrated circuit device 40 may be coupled with the integrated circuit device 50, using signal lines or the like provided on the heat dissipation substrate 20.

By using a coupling method employing bonding wires in this manner, signal couplings can be made at low cost, with a comparatively simple manufacturing process. For example, by using a wire bonding device when manufacturing the electro-optical apparatus 10, signal lines can be coupled between the electro-optical panel 30 and the integrated circuit devices 40 and 50, which makes it possible to simplify the manufacturing process, reduce the cost of the electro-optical apparatus 10, and the like.

Additionally, according to one exemplary embodiment, the integrated circuit devices 40, 50, and the like are disposed on the heat dissipation substrate 20 over an insulating body. In a case where the heat dissipation substrate 20 is formed from a metal such as aluminum or magnesium, for example, an oxide film or the like that will serve as an insulating body is formed on a surface of the heat dissipation substrate 20, as described earlier, and the integrated circuit devices 40, 50, and the like are then mounted. Accordingly, a situation where the heat dissipation substrate 20 and the integrated circuit devices 40, 50, and the like are electrically connected can be prevented. In this case, in a case where the back surface sides of the IC chips in the integrated circuit devices 40, 50, and the like are set to the same electric potential as the heat dissipation substrate 20, this type of oxide film or the like serving as an insulating body need not be formed.

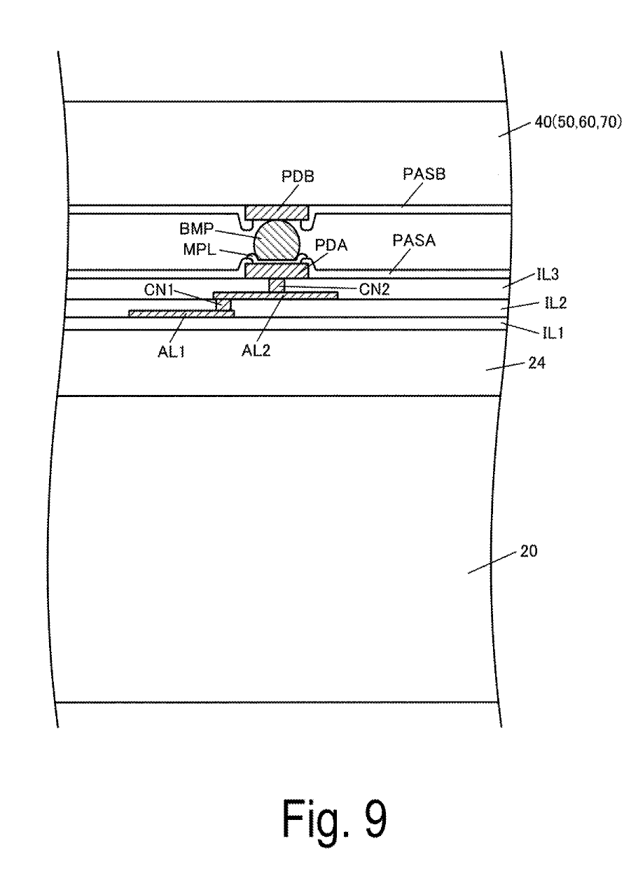

Additionally, according to one exemplary embodiment, the electro-optical apparatus 10 may include a silicon substrate 24 provided between the integrated circuit device 40 and the heat dissipation substrate 20, as illustrated in FIG. 9. A wiring layer for making at least one of a signal coupling between the electro-optical panel 30 and the integrated circuit device 40, and a signal coupling between the integrated circuit device 40 and the integrated circuit device 50, for example, is formed in the silicon substrate 24. For example, in FIG. 9, oxide films IL1 and IL2 are formed on the silicon substrate 24, and wiring layers AL1 and AL2 are formed on the oxide films IL1 and IL2. The wiring layers AL1 and AL2 are wiring layers formed from metals such as aluminum, and signal couplings (wiring) between the electro-optical panel 30 and the integrated circuit device 40, and signal couplings (wiring) between the integrated circuit device 40 and the integrated circuit device 50, are made using these two wiring layers AL1 and AL2.

An oxide film IL3 is formed on the oxide film IL2, and a pad PDA (broadly defined as a terminal) is formed on the oxide film IL3 using the uppermost wiring layer (a pad metal). For example, the pad PDA is formed in an opening portion formed in a passivation PASA. A bump BMP (an Au bump) is formed on the pad PDA. Note that multilayer plating MPL formed from Ni/Pd/Au or the like is formed on the pad PDA, and the bump BMP is formed on the plating MPL. Forming the plating MPL between the pad PDA in the bump BMP in this manner makes it possible to improve the coupling strength.

This bump BMP is then electrically connected to a pad PDB (a terminal) of the integrated circuit device 40 (50, 60, 70), for example. For example, the pad PDB is formed in an opening portion formed in a passivation PASB, and an upper end portion of the bump BMP is electrically connected to the pad PDB. In other words, the IC of the integrated circuit device 40 (50, 60, 70) is flip-mounted. Accordingly, the pad PDA in the chip of the silicon substrate 24 for making a signal coupling can be coupled with the pad PDB of the integrated circuit device 40 (50, 60, 70) by a bump. This makes it possible to realize a signal coupling between the electro-optical panel 30 and the integrated circuit device 40, a signal coupling between the integrated circuit device 40 and the integrated circuit device 50, and the like. Accordingly, signal couplings between the electro-optical panel 30 and the integrated circuit devices 40, 50, 60, and 70 can be realized without wire bonding coupling such as that illustrated in FIGS. 1 to 3.

It is also possible to make a signal coupling only between the electro-optical panel 30 and the integrated circuit device 40, or only between the integrated circuit device 40 and the integrated circuit device 50, using the wiring layers AL1 and AL2 of the silicon substrate 24, bump coupling, and the like, and make a signal coupling for the other set of these elements through another form of coupling. Additionally, the bump BMP is a projection-shaped coupling electrode formed on the pad. Bump coupling is a method of coupling through the bump BMP, which is a metal projection (a conductive projection), with the pads (terminals) facing each other. Compared to wire bonding coupling, bump coupling has an advantage in that the coupling length can be shortened. Note that the bump BMP may be a resin-core bump formed by metal-plating a bump core formed of resin.

With a configuration that provides the silicon substrate 24 for signal coupling as in FIG. 9, for example, the oxide films IL1, IL2, IL3, and the like serve as an insulating body provided between the integrated circuit devices 40, 50, and the like, and the heat dissipation substrate 20. In other words, the oxide films IL1, IL2, IL3, and the like serve as an insulating body, and the integrated circuit devices 40, 50, and the like are electrically insulated from the heat dissipation substrate 20. Note that in one exemplary embodiment, a flexible substrate for signal coupling may be provided between the integrated circuit devices 40, 50, and the like, and the heat dissipation substrate 20, for example. In this case, the signal coupling between the electro-optical panel 30 and the integrated circuit device 40, the signal coupling between the integrated circuit device 40 and the integrated circuit device 50, and the like can be realized by signal lines formed in the flexible substrate. Additionally, for example, an oxide film may be formed on the surface of the heat dissipation substrate 20 and a wiring pattern may be formed directly on the oxide film. In this case, the signal coupling between the electro-optical panel 30 and the integrated circuit device 40, the signal coupling between the integrated circuit device 40 and the integrated circuit device 50, and the like can be realized by the wiring pattern formed on the oxide film.

2. Integrated Circuit Device

Specific examples of the configuration of the integrated circuit devices 40, 50, 60, and 70 illustrated in FIGS. 1 to 3 will be described next.

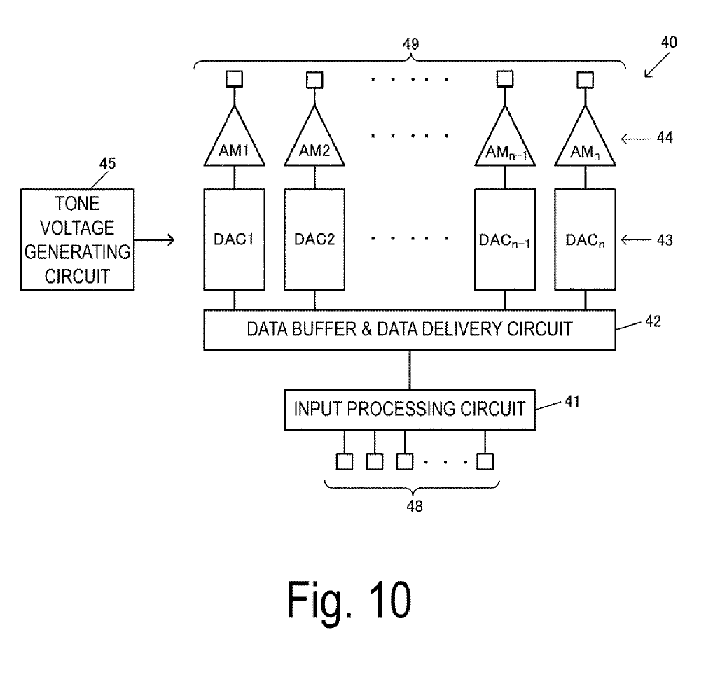

FIG. 10 illustrates a specific example of the configuration of the integrated circuit device 40 for panel driving. This integrated circuit device 40 includes an input processing circuit 41, a data buffer & data delivery circuit 42, a D/A conversion unit 43, an amp unit 44, and a tone voltage generating circuit 45. The input processing circuit 41 takes input signals, such as image signals and control signals, as inputs through an input terminal group 48 of the integrated circuit device 40, and carries out input processing. The data buffer & data delivery circuit 42 carries out processing for buffering image data (tone data) corresponding to image signals, delivering the data to the D/A conversion unit 43, and the like. For example, delivery processing called phase development processing is carried out. The D/A conversion unit 43 includes a plurality of D/A converters DAC1 to DACn, and carries out D/A conversion of the image data. Specifically, in the D/A conversion, a voltage corresponding to tone data, which is image data, is selected from among a plurality of tone voltages generated by the tone voltage generating circuit 45, as a data voltage (source voltage). The amp unit 44 includes a plurality of amps AM1 to AMn, and buffers the plurality of data voltages (source voltages) from the D/A conversion unit 43 and outputs the voltages to an output terminal group 49. The output terminal group 49 is electrically connected to the electro-optical panel 30 by wires, such as through wire bonding.

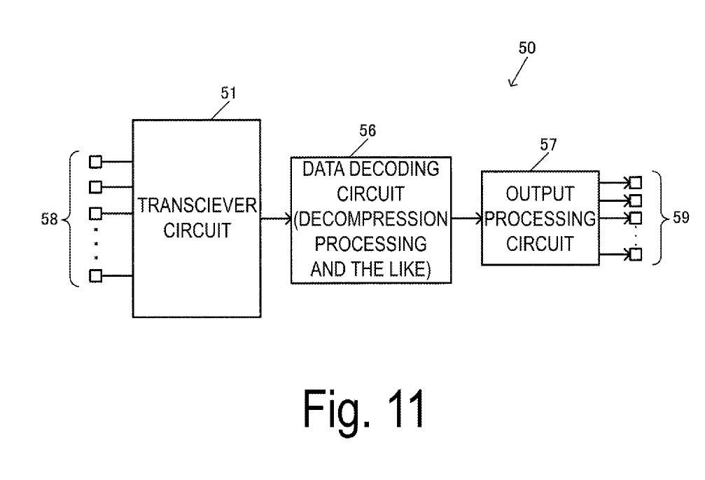

FIG. 11 illustrates a specific example of the configuration of the integrated circuit device 50 for interface processing. The integrated circuit device 50 includes a transceiver circuit 51 (an input processing circuit), a data decoding circuit 56, and an output processing circuit 57. The transceiver circuit 51 carries out input processing of signals inputted from an input terminal group 58 of the integrated circuit device 50. Specifically, the transceiver circuit 51 carries out physical layer processing, link layer processing, and the like based on the interface standard of the interface processing. For example in a case where the interface standard is USB, physical layer processing, link layer processing, and the like based on the USB standard is carried out. For example, reception processing and transmission processing of differential input signals (DP, DM), packet analysis processing and generation processing, and the like are carried out. The data decoding circuit 56 carries out decoding processing on image data received from an external device via the transceiver circuit 51. For example, in a case where the image data has been compressed, decoding processing such as processing for decompressing the compressed image data is carried out. Compressing the image data in this manner before transfer makes it possible to transfer large amounts of image data at high speeds. The output processing circuit 57 carries out processing for outputting signals based on the post-decoding processing image data and the like, and outputs image signals, control signals, and the like to the integrated circuit device 40 and the like via an output terminal group 59 of the integrated circuit device 50. For example, the signals are converted into signals in a signal format used by the integrated circuit device 40 for panel driving, and are then outputted. For example, output processing of converting signals into an RGB interface signal format or the like is carried out. Note that the transmission of signals from the integrated circuit device 50 for interface processing to the integrated circuit device 40 for panel driving may be signal transmission using low-amplitude differential signals such as LVDS, for example.

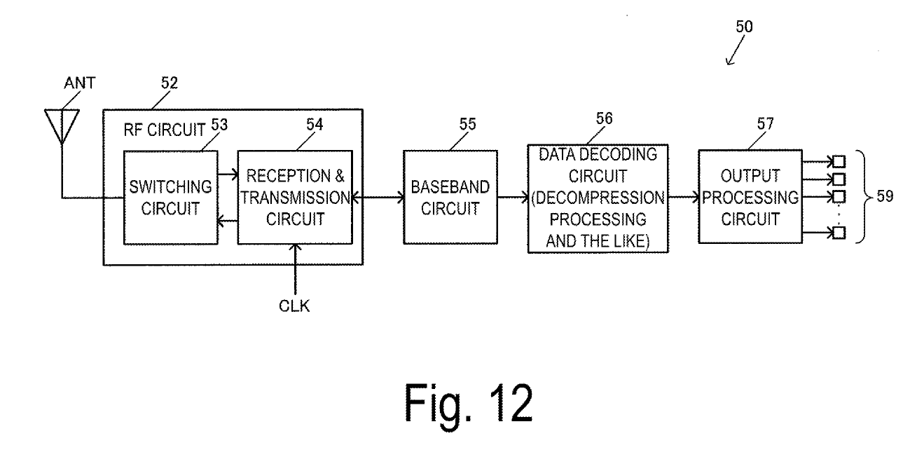

FIG. 12 illustrates a specific example of the configuration of the integrated circuit device 50 that carries out wireless communication interface processing. The integrated circuit device 50 includes an RF circuit 52, a baseband circuit 55, the data decoding circuit 56, and the output processing circuit 57. The RF circuit 52 is connected to an antenna ANT (an inductor) provided in the antenna unit 90 or 92 illustrated in FIG. 2 or 3. The RF circuit 52 includes a switching circuit 53 for switching between receiving and sending in wireless communication, and a receiving & sending circuit 54 that receives and sends in the wireless communication. The receiving & sending circuit 54 operates under the supply of a clock signal CLK for wireless communication from an oscillation circuit (not illustrated). The baseband circuit 55 carries out baseband processing in the wireless communication. The operations of the data decoding circuit 56 and the output processing circuit 57 are identical to those illustrated in FIG. 11, and thus will not be described in detail.

FIG. 13 illustrates a specific example of the configuration of the integrated circuit device 60 for power supply. The integrated circuit device 60 includes the noise filter unit 62, a monitoring unit 63, a regulator 64, a reference voltage generating unit 65, and a power supply starting sequence processing unit 66. The noise filter unit 62 carries out filter processing for reducing power supply noise. Specifically, the noise filter unit 62 carries out noise filter processing that reduces power supply noise in a given frequency band. For example, band-elimination filter processing that reduces a power supply noise frequency band component is carried out. The monitoring unit 63 carries out a power supply monitoring process. For example, processing of monitoring the power supply when the power supply is turned on, processing of monitoring fluctuations in power supply voltages, and the like are carried out. The regulator 64 adjusts an external power supply voltage and generates various power supply voltages, for example. The generated power supply voltages are supplied to the integrated circuit devices 40, 50, 60, and 70. The reference voltage generating unit 65 generates a voltage to serve as a reference to various types of analog circuits and the like. The reference voltage generating unit 65 can be realized by a band gap circuit, for example. The power supply starting sequence processing unit 66 carries out power supply startup sequence processing when the power supply is turned on. For example, processing for a startup sequence is carried out when the power supply is turned on.

FIG. 14 illustrates a specific example of the configuration of the integrated circuit device 70 for memory. The integrated circuit device 70 includes an image memory unit 71, the memory unit 72 for decoding processing, a memory unit 73 for system configuration, and a memory unit 74 for gamma conversion. The image memory unit 71 is a memory unit including VRAM, for example. The memory unit 72 for decoding processing is a memory unit used in the decoding processing, such as decompression processing, by the integrated circuit device 50. The memory unit 72 is used as a work region for the decoding processing and the like. The memory unit 73 for system configuration is a memory unit that stores various types of information for the system configuration of the electro-optical apparatus 10. The memory unit 73 stores operating configuration information, various types of parameter information, and the like, for example. The memory unit 74 for gamma conversion is a memory unit that stores configuration information for gamma conversion properties (tone voltage properties) used by the integrated circuit device 40 for panel driving.

3. Electronic Apparatus, Projector

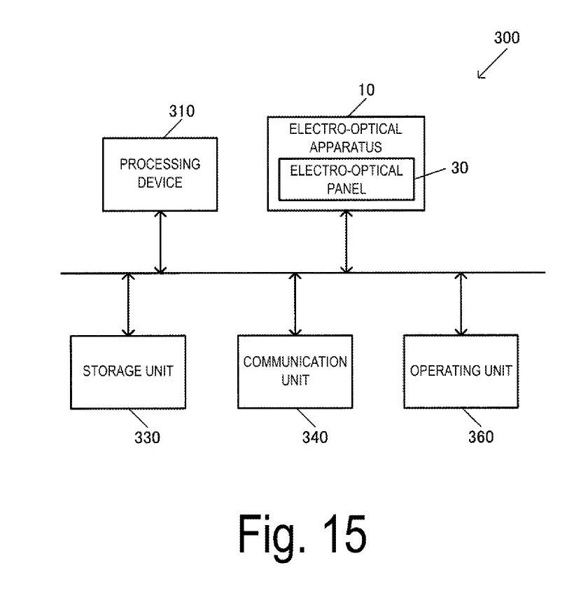

FIG. 15 illustrates an example of the configuration of an electronic apparatus 300 including the electro-optical device 10 according to one exemplary embodiment. The electronic apparatus 300 includes the electro-optical device 10, a processing device 310, a storage unit 330 (storage device, memory), a communication unit 340 (communication circuit, communication device), and an operating unit 360 (operating device). Various types of electronic apparatuss including display devices, such as a projector, a head-mounted display, a mobile information terminal, a vehicle-mounted device (e.g., a meter panel, a car navigation system, or the like), a mobile game console, a robot, or an information processing device, can be considered as specific examples of the electronic apparatus 300.

The processing device 310 carries out control processing for the electronic apparatus 300, various types of signal processing, and the like. The processing device 310 can be realized by, for example, a processor such as a CPU or an MPU, an ASIC, or the like. The storage unit 330 stores data inputted from the communication unit 340, or functions as a work memory for the processing device 310, for example. The storage unit 330 can be realized by, for example, semiconductor memory such as RAM or ROM, a magnetic storage device such as an HDD, an optical storage device such as a CD drive or a DVD drive, or the like. The communication unit 340 is a data interface that inputs and outputs image data, control data, and the like. Communication processing carried out by the communication unit 340 may be wired communication processing or wireless communication processing. The operating unit 360 is a user interface that accepts various types of operations from a user. For example, the operating unit 360 can be realized by buttons, a mouse, a keyboard, a touch panel installed in the electro-optical panel 30, or the like.

FIG. 16 illustrates an example of the configuration of the projector 302 including the electro-optical device 10 according to one exemplary embodiment. The projector 302 illustrated in FIG. 16 includes the electro-optical device 10 according to one exemplary embodiment and a projection unit 370. For example, the projector 302 includes the projection unit 370 in addition to the processing device 310, the storage unit 330, the communication unit 340, and the operating unit 360 illustrated in FIG. 15. The projection unit 370 includes a light source 380 and an optical system 390. The light source 380 is realized by a lamp unit including a white light source such as a halogen lamp, for example. The optical system 390 is realized by lenses, prisms, mirrors, or the like, for example. In a case where the electro-optical panel 30 is a transmissive type, light from the light source 380 is incident on the electro-optical panel 30 via the optical system 390 and the like, and the light transmitted by the electro-optical panel 30 is projected onto a screen. In a case where the electro-optical panel 30 is a reflective type, light from the light source 380 is incident on the electro-optical panel 30 via the optical system 390 and the like, and the light reflected by the electro-optical panel 30 is projected onto a screen.

Although some exemplary embodiments have been described in detail above, those skilled in the art will understand that many modified examples can be made without substantially departing from the novel matter and effects of the disclosure. All such modified examples are thus included in the scope of the disclosure. For example, terms in the descriptions or drawings given even once along with different terms having identical or broader meanings can be replaced with those different terms in all parts of the descriptions or drawings. All combinations of the exemplary embodiments and modified examples are also included within the scope of the disclosure. Furthermore, the configurations and operations of the electro-optical device, the electro-optical panel, the integrated circuit device, the heat dissipation substrate, the electronic apparatus, the projector, and the like are not limited to those described in some exemplary embodiments, and many modified examples are possible as well.

What is claimed is:

1. An electro-optical device comprising:
an electro-optical panel;
a heat dissipation substrate;
a first integrated circuit device disposed on the heat dissipation substrate and configured to drive the electro-optical panel;
a second integrated circuit device disposed on the heat dissipation substrate and configured to carry out interface processing between the electro-optical panel and an external device; and
a connector, coupled with the second integrated circuit device, that includes a signal terminal used for the interface processing.

2. The electro-optical device according to claim 1, wherein
the second integrated circuit device is configured to carry out the interface processing according to a given interface standard; and
the connector is a connector according to the given interface standard.

3. The electro-optical device according to claim 2, wherein
the given interface standard is a Universal Serial Bus (USB), embedded Display Port (eDP), or High Definition Multimedia Interface (HDMI) interface standard.

4. The electro-optical device according to claim 1, wherein
the first integrated circuit device is disposed on a first direction side of the electro-optical panel,
the second integrated circuit device is disposed on the first direction side of the first integrated circuit device, and
the connector is disposed on the first direction side of the second integrated circuit device.

5. An electro-optical device comprising:
an electro-optical panel;
a heat dissipation substrate;
a first integrated circuit device disposed on the heat dissipation substrate and configured to drive the electro-optical panel;
a second integrated circuit device disposed on the heat dissipation substrate and configured to carry out wireless communication interface processing between the electro-optical device and an external device; and
an antenna unit for wireless communication.

6. The electro-optical device according to claim 5, wherein
the first integrated circuit device is disposed on a first direction side of the electro-optical panel,
the second integrated circuit device is disposed on the first direction side of the first integrated circuit device, and
the antenna unit is disposed on the first direction side of the second integrated circuit device.

7. The electro-optical device according to claim 1, wherein
when viewed in plan view in a direction orthogonal to the heat dissipation substrate, the first integrated circuit device and the second integrated circuit device are disposed overlapping the heat dissipation substrate.

8. The electro-optical device according to claim 1, wherein
the first integrated circuit device and the second integrated circuit device are disposed on the heat dissipation substrate with an insulating body located between the first integrated circuit device and the second integrated circuit device, and the heat dissipation substrate.

9. The electro-optical device according to claim 1, wherein
at least one of the electro-optical panel and the first integrated circuit device, and the first integrated circuit device and the second integrated circuit device, are coupled using bonding wires.

10. The electro-optical device according to claim 1, further comprising:
a silicon substrate disposed between the first and second integrated circuit devices and the heat dissipation substrate,
wherein a wiring layer is formed in the silicon substrate for making at least one of a signal coupling between the electro-optical panel and the first integrated circuit device, and a signal coupling between the first integrated circuit device and the second integrated circuit device.

11. The electro-optical device according to claim 1, further comprising:
a third integrated circuit device disposed on the heat dissipation substrate and configured to supply power to the first integrated circuit device and the second integrated circuit device.

12. The electro-optical device according to claim 11, wherein
the third integrated circuit device includes a noise filter unit configured to reduce power supply noise in a given frequency band.

13. The electro-optical device according to claim 11, further comprising:
a power supply connector configured to supply external power to the third integrated circuit device.

14. The electro-optical device according to claim 1, further comprising:
an inductor for non-contact power transmission, configured to supply power to the electro-optical device without making contact with the electro-optical device.

15. The electro-optical device according to claim 1, wherein
the second integrated circuit device is configured to carry out image data decoding processing; and
the electro-optical device comprises a fourth integrated circuit device, disposed on the heat dissipation substrate, and including a memory unit for the decoding processing.

16. The electro-optical device according to claim 1, wherein
a number of pixels in the electro-optical panel is greater than or equal to 3840×2160, and a transfer rate of the interface processing is greater than or equal to 600 Mbps.

17. An electro-optical device comprising:
an electro-optical panel;
a heat dissipation substrate;
a first integrated circuit device disposed on the heat dissipation substrate and configured to drive the electro-optical panel;
a second integrated circuit device disposed on the heat dissipation substrate and configured to carry out interface processing between the electro-optical panel and an external device.

18. An electronic apparatus comprising the electro-optical device according to claim 1.

19. An electronic apparatus comprising the electro-optical device according to claim 17.

20. A projector comprising:
the electro-optical device according to claim 1; and
a projection unit including a light source and an optical system.

21. A projector comprising:
the electro-optical device according to claim 17; and
a projection unit including a light source and an optical system.
